(19) United States
(12) Patent Application Publication
(10) Pub. No.: US 2024/0195933 A1
(43) Pub. Date: Jun. 13, 2024

(54) VIDEO SURVEILLANCE PLAYBACK SYSTEM WITH MULTI-TIERED STORAGE

(71) Applicant: Jay Jason Bartlett, San Diego, CA (US)

(72) Inventor: Jay Jason Bartlett, San Diego, CA (US)

(21) Appl. No.: 18/065,506

(22) Filed: Dec. 13, 2022

(30) Foreign Application Priority Data
Jun. 22, 2022 (JP) 2022-100543

(51) Int. Cl. H04N 5/765; G06F 3/06; G11B 15/68; H04N 5/76; H04N 5/782; H04N 5/907; H04N 7/18

(52) U.S. Cl. CPC H04N 5/765; G06F 3/0608; G06F 3/0647; G06F 3/0685; G11B 15/6895; H04N 5/7605; H04N 5/782; H04N 5/907; H04N 7/181

(57) ABSTRACT

This invention relates to video surveillance management solutions. More specifically this invention relates to the integration of multiple tiers of dissimilar computer data storage technologies in such a manner to deliver longer term video retention and easy video playback. The device captures video data from multiple surveillance cameras and stores it on computer hard drive and then replicates to a second tier of digital data tape storage. Video retention policies are determined from parameters for the number of cameras, frame rates, resolution, and number of days of video retention desired. Storage procedures are set for multiple tiers of video storage that will allow for the highest quality video to be recorded without alteration or manipulation. A human video operator will then have the ability to select any available recorded video under management and have that video retrieved and available for display and playback without any additional steps or human interaction.

### CROSS-REFERENCE TO RELATED APPLICATIONS

NONE

### STATEMENT REGARDING FEDERALLY SPONSORED RESEARCH OR DEVELOPMENT (IF APPLICABLE)

No federally sponsored research and development was provided for this invention.

### REFERENCE TO SEQUENCE LISTING, A TABLE, OR A COMPUTER PROGRAM LISTING COMPACT DISC APPENDIX (IF APPLICABLE)

Not Applicable

### FIELD OF CLASSIFICATION SEARCH

CPC Class: G06F 3/0601, 3/0608, 3/0617, 3/0619, 3/0628, 3/0629, 3/0631, 3/0632, 3/0633, 3/0634, 3/0635; 16/125, 16/7837; G08B 13/19656; G08B 13/19676; H04N 21/274; 21/4223; 21/4334; 7/181;

This proposed invention relates to the physical security industry specifically the video surveillance market. Moreover, this invention utilizes video surveillance cameras, in a video surveillance network, with video management software (VMS) to execute computer software in such a manner to ingest video, capture video to various data storage devices, and manipulate the recorded video throughout an infrastructure of computer hardware devices to allow a human video operator to recall, display, and playback any available recorded video under management without any separate steps, interaction, or human intervention.

### BACKGROUND OF THE INVENTION

### Background Art

U.S. Pat. No. 6,041,361A Sensormatic Electronics Corporation
   Digital video recorder providing separate pipelining for odd and even fields from a single camera
U.S. Pat. No. 6,144,797A Sensormatic Electronics Corporation
   Intelligent video information management system performing multiple functions in parallel
US20030185296A1 Masten James W.
   System for the capture of evidentiary multimedia data, live/delayed off-load to secure archival storage and managed streaming distribution
US20040119820A1 Murakami Corporation
   Transmitter for surveillance camera, and surveillance system
US20040143602A1 Antonio Ruiz
   Apparatus, system and method for automated and adaptive digital image/video surveillance for events and configurations using a rich multimedia relational database
US20040155958A1 Mi-Suen Lee
   User assisted customization of automated video surveillance systems
US20050102704A1 Rudy Prokupets
   Multiregional security system integrated with digital video recording and archiving
US20050271251A1 Russell Stephen G
   Method for automatically reducing stored data in a surveillance system
US20060066720A1 Martin Renkis
   Wireless video surveillance system and method with external removable recording
US20060078047A1 International Business Machines Corporation
   Video analysis, archiving and alerting methods and apparatus for a distributed, modular and extensible video surveillance system
US20060176369A1 Meritt Ronald R
   Portable, self-contained video recording and display system and method
US20060184553A1 Matsushita Electric Industrial Co., Ltd.
   Distributed MPEG-7 based surveillance servers for digital surveillance applications
US20060192675A1 Renkis Martin A
   Enterprise video intelligence and analytics management system and method
US20060274829A1 A4S Security, Inc.
   Mobile surveillance system with redundant media
US20060274828A1 A4S Security, Inc.
   High capacity surveillance system with fast search capability
US20070217501A1 A4S Security, Inc.
   Surveillance system with digital tape cassette
US20090079823A1 Dirk Livingston Bellamy
   Methods and systems for operating a video surveillance system
U.S. Pat. No. 7,382,244B1 Donovan, Hussain
   Video surveillance, storage, and alerting system having network management, hierarchical data storage, video tip processing, and vehicle plate analysis
U.S. Pat. No. 7,460,149B1 Donovan, Hussain
   Video data storage, search, and retrieval using meta-data and attribute data in a video surveillance system
U.S. Pat. No. 7,760,230B2 Russell, Vallone, Freeman, Fleischer, Haupt
   Method for automatically reducing stored data in a surveillance system
U.S. Pat. No. 8,013,738B2 Donovan, Hussain
   Hierarchical storage manager (HSM) for intelligent storage of large volumes of data
U.S. Pat. No. 8,797,404B2 Joseph, Perumal
   Managing memory in a surveillance system
U.S. Pat. No. 8,953,038B2 Lu, Sheinin
   Distributed video surveillance storage cost reduction using statistical multiplexing principle
U.S. Pat. No. 9,986,209B2 Meyer
   Method and system for managing data from digital network surveillance cameras
U.S. Ser. No. 10/341,684B2 Drako, Roskowski
   High definition surveillance image storage optimization apparatus and methods of retention triggering

### OTHER REFERENCES CITED

Video Surveillance And The Storage Challenge, By LTO BlogBytes, https://www.Ito.org/2021/09/video-surveillance-storace-challenges/, September, 2021
Video Surveillance Advancements Lead To Data Storage Challenges, Securitylnformed.com magazine, https://www.securityinformed.com/insiahts/video-surveillance-data-storaqe-challeriges-co-10817-qa-co-2851-qa-co-11453-qa.21002.html, date unknown
What are guidelines for cloud-based video surveillance storage? By Brien Posey, https://www.techtarget.com/searchstorage/answer/What-are-quidelines-for-cloud-based-video-surveillance-storage, 5 May 2022
Worldwide Video Surveillance Storage Industry to 2027, ResearchAndMarkets.com, https://www.yahoo.com/entertainment/worldwide-video-surveillance-storage-industry-134800487.html, Dec. 6, 2021
Video Surveillance Storage Market, Persistence Market Research, https://www.persistencemarketresearch.com/market-research/video-survieillance-storage-market.asp, date unknown
LTO digital computer data tape: LTO Consortium, https://www.ito.org/roadmap/, date unknown
T10000 digital computer data tape: Wikipedia Reference: https://en.wikipedia.org/wiki/StorageTek tape formats, date unknown

### Technical Field

Summarizing those previously issued patents highlights the numerous prior arts for the management and storage of video surveillance video feeds. This video feed data has grown significantly in size with technology advances of video surveillance cameras and the availability of surveillance cameras to the general market. Prior art has created various solutions for the handling and storage of video surveillance data. Prior art, from other marketplaces—namely the media and entertainment industry—has used various video data storage technologies to handle the amount of video data under management.

Prior art has also implemented solutions to distribute the video storage to numerous storage devices to minimize the impact of such quantities of video data on one storage device. A great many prior art approaches have created ways to alter, manipulate, or edit the video data itself to reduce the file size of the video data in an attempt to store more video in the same amount of storage capacity. Other prior art solutions created ways to offload, archive, or to move video data to an offline data storage device to, again, reduce the amount of video data under active management.

What all of these prior art methods and systems have done is to mitigate the initial video data under manage in ways to make it more manageable utilizing known traditional storage techniques.

What the proposed submitted invention creates is a new method for storing and replicating video data on a proposed system of multiple tiers of video storage in such an automatic way so that the human video operator, using unique video surveillance management software (VMS) can recall, display, and playback any available recorded video without any alteration of the video data, without any additional steps by the video operator, or with any other human intervention. It is this recall, retrieval, and non-interventive video playback that is the primary focus of this proposed invention.

Beginning in 2008, when the video surveillance industry saw a major transition from analog surveillance cameras and analog video recorders (VCR tapes) as the primary technology over to newer digital surveillance cameras (IP-cameras) and computer hard-disk drive video storage systems, managing the video storage retention of these surveillance systems has been a daunting challenge and one that many have tried to improve upon ever since.

As per any invention, the background of this proposed invention is critically important to fully appreciate the impact of this offered invention. Many other prior art and patents have been issued attempting to mitigate the video surveillance storage retention challenge from various perspectives, however, none of the previous implementations have been able to provide both extendable, scalable, and affordable video storage retention and the ability for the human video operator to playback, review, and analyze the entire cache of stored video data without any additional steps or intervention.

As is known, typically, one or more video cameras are purposefully positioned throughout an environment used to capture images of people, other objects, and activities that come within the range of the cameras. Video surveillance systems can transmit surveillance information via wire-based and wireless technology and across the Internet back to a video management software (VMS) program.

As is known, traditional surveillance systems record and store surveillance footage to various video storage mediums for future playback, reference, and analysis. By design and desire, video surveillance data generated by a surveillance camera is stored in its entirety.

With the technology advances of the surveillance IP-cameras, the digital files generated by those cameras have become very large and demand a great deal of computer storage space. In addition, in order for a surveillance system to fully monitor an area, multiple cameras are generally required. As the number of cameras in a surveillance system increases, the amount of video data that is to be stored also significantly increases.

As is known, to accommodate these storage requirements, many traditional surveillance system architectures make use of video data storage that overwrites older stored video data with newer video data after a certain timeframe. An example would be when a traditional system storage capacity can support two months' worth of continuous surveillance video data. After those two months expire, the traditional system storage capacity is reused, starting by overwriting the oldest video data. Obviously, older surveillance video data, which may still have value, is lost in a system that performs such an overwrite storage design.

As is known, there are traditional systems that alternatively back up or archive all or some parts of the video data wholesale to offline archival storage media once the video data has reached the previously described storage capacity or set retention period. That is, all video data captured by the surveillance system is archived after a set period of time passes. In these systems, once data has been archived or backed-up, it is no longer online or easily available to the human video operator user without several additional steps or other human interaction to retrieve desired recorded video.

As is known, those traditional systems with archival processes will require some type of human intervention and additional steps to be able to recall, playback, and review any older or archived video data then what is currently recorded in primary system storage. The requested video archival media must be identified and reloaded in order to view or obtain information about a particular event caught by surveillance video. Typically, in those traditional systems, any video data that is archived is considered outside of the normal video operator playback and review process.

Although that method allows video data to be stored for a longer period of time, there is no practical way to identify, extract, or peruse archived surveillance video data. In many cases, this is a very complex and time-consuming task and becomes unviable to the human operator. Much prior art has made claims to using multiple tiers of data storage for the purpose of recording and storing video, yet current prior art has not describe nor defined how to identity, recall, and playback such recorded video, especially without significant additional steps or other human interaction.

As is known, other traditional systems may attempt to pre-determine the importance of certain surveillance video data and migrate or replicate that video data to other tiers or medium of data storage. This concept assigns a pre-determined importance level on the video data to ascertain whether to delete, archive, or otherwise reduce the quality of the video data itself, thereby increasing the previously allocated video data storage capacity of the surveillance system.

As is known, there are numerous other video surveillance systems in place that attempt to manipulate the stored surveillance video data by various methods of reducing the video frame rate, and/or the video resolution quality, and/or the color depth of the video all in attempt to reduce the overall data file size of the video. In other words, in an attempt to keep as much video data stored as possible on the available data storage infrastructure, these traditional systems greatly manipulate the video data.

As is known, manipulating, altering, editing, or changing any video data evidence is not admissible in a court of law and thus undermines a valuable purpose of a video surveillance system in the first place; having evidence of an event that occurred.

As is known, video surveillance systems have used numerous data storage technologies from analog to digital systems. In the analog systems, many used VCR/VHS tape introduced in the market in the mid-1970s. In the digital system, many use digital computer hard drives, CDs, DVDs, and other digital storage technologies.

As is known, the various traditional systems have approached the video surveillance data storage challenge from the perspective of limiting the video data storage capacity to begin with, or by manipulating and reducing the video data file itself. These traditional systems have also attempted to utilize multiple tiers of data storage with the approach to archive or move offline the video data from the primary storage system. This removes the video from the primary video management software playback and review process and creates additional steps and intervention by human operators in order to identify, recall, and playback any available recorded video.

As is known, there is a significant technical difference between analog VHS tape and digital computer data tape such as Linear Tape Open (LTO) or T10000 format tape.

As is known, Linear Tape Open (LTO) tape and T10000 tape is used in various markets, such as the media and entertainment industry, which stores production video to tape systems. However, those other market systems and techniques that utilize the recorded video is significantly different than the video surveillance industry.

Therefore, as recognized by the present inventor, what are needed are methods, techniques, and a system of video surveillance management that can intelligently store large amounts of surveillance video data utilizing multiple tiers of data storage in such an infrastructure that keeps the quality and integrity of the video data whole and intact, keeps all recorded video easily assessable to the human video user/operator without any additional steps or human intervention (nor additional software) and without any pre-determination of such needed video data.

The techniques described herein of the proposed invention provide for managing video data storage in a traditional video management software (VMS) program utilizing multiple tiers of storage, specifically, a tier of traditional computer hard disk storage as well as a tier of digital computer data tape such as Linear Tape Open (LTO) or T10000 tape.

One problem with most, if not all, current approaches to video surveillance systems—and video data storage management more specifically—is that those solutions require extra steps outside of the video surveillance management software by the human operator or other staff personnel. This becomes a usability issue that becomes unpractical, and ultimately unviable to initiate those extra steps when in the process of needing to playback and review recorded video frequently.

### SUMMARY OF THE INVENTION

In general, the proposed invention provides overarching methods and techniques coupled with appropriate computer hardware devices for intelligently storing surveillance data in a video surveillance management system utilizing a multi-tiered storage infrastructure. Additionally, methods of extending the amount of calendar time for which video data can be stored on a data storage device as well as the ease and consistent operation by the human video operator of such a system are provided herein.

One embodiment of the present invention is the video surveillance software method along with its accompanying video data storage hardware (“the system”) wherein the disclosed methods apply decision criteria, such as rules, configuration data, and preferences to support intelligent automatic video data storage onto multiple tiers of video data storage and the seamless video playback for a human video operator.

One embodiment of the present invention would include, but is not limited to, one or more surveillance cameras for capturing video data, one or more live and recorded video playback stations, one or more tiers of video data storage such as traditional hard disks, and one or more tiers of video data storage such as digital computer data tape (e.g., Linear Tape Open or T10000 formats), and the overarching computer program for video management software (VMS).

It is expressly stated that the usage of digital computer data tape storage technology such as (but not limited to) Linear Tape Open (LTO) or T10000 format Tape tier of video storage is utilized automatically on the recording/storing process of the VMS system as well as the operator playback and review process of the VMS system. It is this all-encompassing system that is ultimately unique to this present invention and differs in implementation, utilization, and implementation from prior art.

The video surveillance software (VMS) that controls and manages the overall system holds one embodiment of the present invention wherein the VMS software will determine the availability of the first tier of video data storage capacity and record and store all new incoming video data.

The VMS will also determine when it is necessary to replicate any new stored video from tier one hard disk storage to tier two tape storage. The VMS will also determine when the second tier (tape) storage is near capacity and begin to overwrite the oldest stored video.

The VMS System will also determine, when a human video operator is requesting recorded video to be played back, which tier of storage the video is currently located and retrieve that video data to display to the video operator automatically and without any additional intervention.

Understanding that the focus of the human video operator is on the VMS software's Timeline functionality and that the execution of the work necessary by the human video operator centers around the use of the VMS software's Timeline feature. Any extra steps other than selecting video from the Timeline or other staff personnel to intercede for the purpose of finding and eventually making recorded video data available for playback becomes untenable, unproductive, and unusable.

It must be understood that since 2008 and the conversion to more digital oriented video surveillance management systems, the market has been accustomed to altering the recorded video either in video quality, video frame rate, or video color or all of the above in order to obtain a level of video retention. It is expressly stated that the present invention does not alter the video in any manner whatsoever.

Reiterating, the present invention does not—in any manner—alter, edit, adjust, or modify the actual video data being recorded. Instead, it specifically uses a multi-tiered video storage infrastructure in a new and unique way that allows for the seamless and straightforward selection of needed video by the human video operator without any other steps or staff needed to retrieve, display, and playback that requested video.

This present invention also does not—in any manner—manage the multiple tiers of video storage in an offline manner. To the contrary, the present invention is specifically delivering all of the recorded video in an online and nearline manner. This is what allows for the human video operator to seamlessly access all of the recorded video under management.

With all of these previous attempts at dealing with the explosive growth of video data, it has not been obvious—otherwise it would have been done over the previous 14 years- to create a method to integrate the VMS software with techniques to manage multiple tiers of computer data storage, especially and specifically computer digital data tape, in such a manner for a human video operator to simply utilize the VMS software Timeline feature to identify and playback any video under management without any additional steps or other human intervention.

### BRIEF DESCRIPTION OF THE DRAWINGS

FIG. 1 is a block diagram of the overarching video capture and playback process in accordance with one embodiment of the present invention;

FIG. 2 is a block diagram of an example of the video ingest process in accordance with one embodiment of the present invention;

FIG. 3 is a block diagram of an example of the video playback process in accordance with one embodiment of the present invention;

FIG. 4 is a table of a Video File Storage Management Database in accordance with one embodiment of the present invention;

FIG. 5 is a table of a Tape Library Storage Database in accordance with one embodiment of the present invention;

FIG. 6 is a table of the Hard Disk Storage Database in accordance with one embodiment of the present invention;

FIG. 7 is a Table of the primary high-level components in accordance with one embodiment of the present invention;

FIG. 8 is a reference to the video management software (VMS) video playback timeline in accordance with one embodiment of the present invention;

FIG. 9 is a reference software screen of the video management software (VMS) video playback user interface (GUI) depicting the dialog message to the video operator to stand by for video retrieval and playback in accordance with one embodiment of the present invention;

FIG. 10 is an exploded view of a robotic digital computer data tape library (aka Jukebox) designed to house a plethora of data tapes for video storage in accordance with one embodiment of the present invention.

### DETAILED DESCRIPTION OF THE INVENTION

The present invention provides a system, a method, and an apparatus for video surveillance and multiple tiers of video data storage allowing for unincumbered recall, retrieval, and playback of any video data under storage management. The present invention collects, stores, and manages video data from various video surveillance cameras and manages the storage placement, movement, and retrieval of all recorded video based on storage capacity attributes of the various tiers of storage available within the apparatus.

### System Architecture

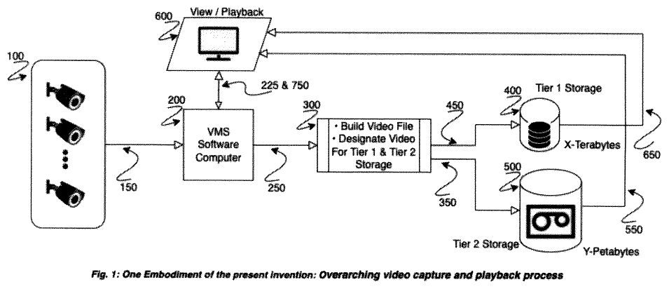

One embodiment of the present invention is a system, a method, and an apparatus for video surveillance and multiple tiers of video data storage allowing for unincumbered recall, retrieval, and playback of any video data under storage management. With reference to FIG. 1 the computer system 200 includes a traditional computer server 7000 with a CPU, significant RAM memory, an NVMe flash storage module, and initial hard disk data storage 400. The system 200 would also include a separate but connected digital computer data Tape storage library 500. A video display unit 600 is also part of the system to view live and recorded video surveillance feeds from a plethora of video surveillance cameras 100.

This system would also include the appropriate networking capabilities to connect to a traditional modern network. This system also includes the computer connectors known as host bus adapters (HBAs) to connect the computer server to the Tape storage library. This system would also contain all of the necessary computer accessories typically found on a modern computer system.

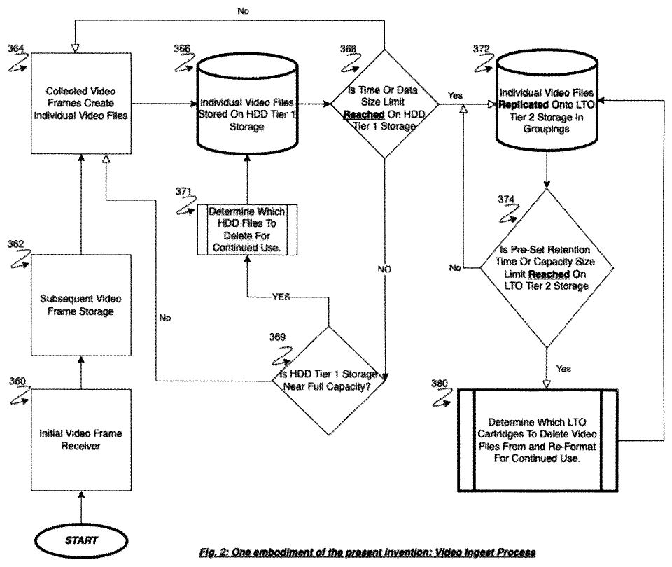

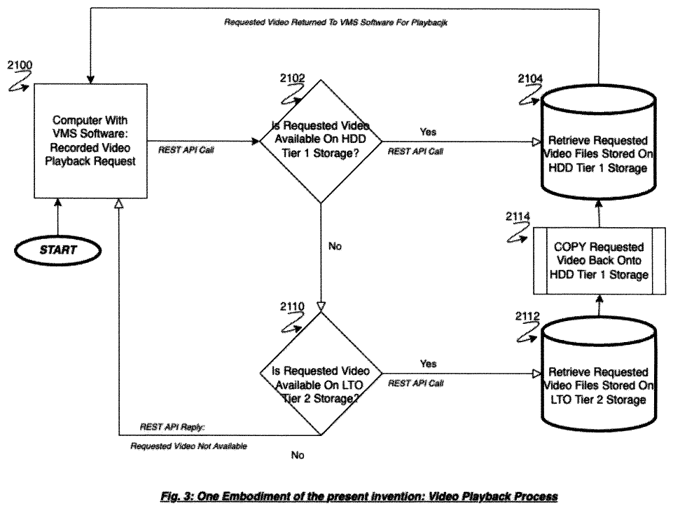

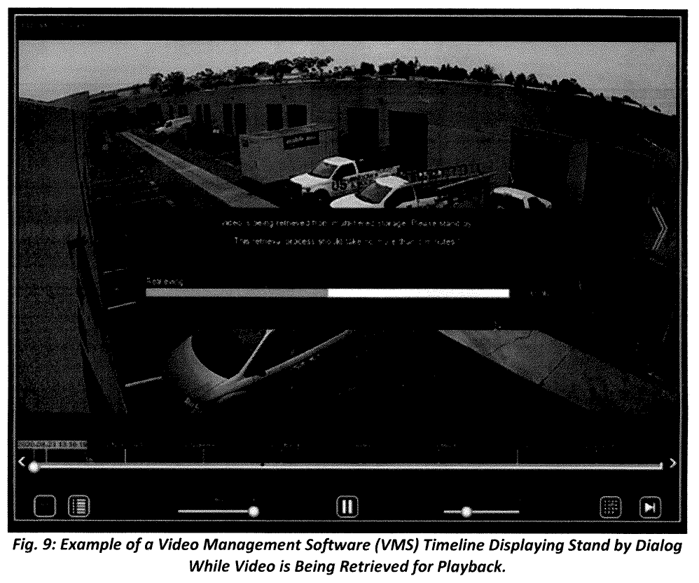

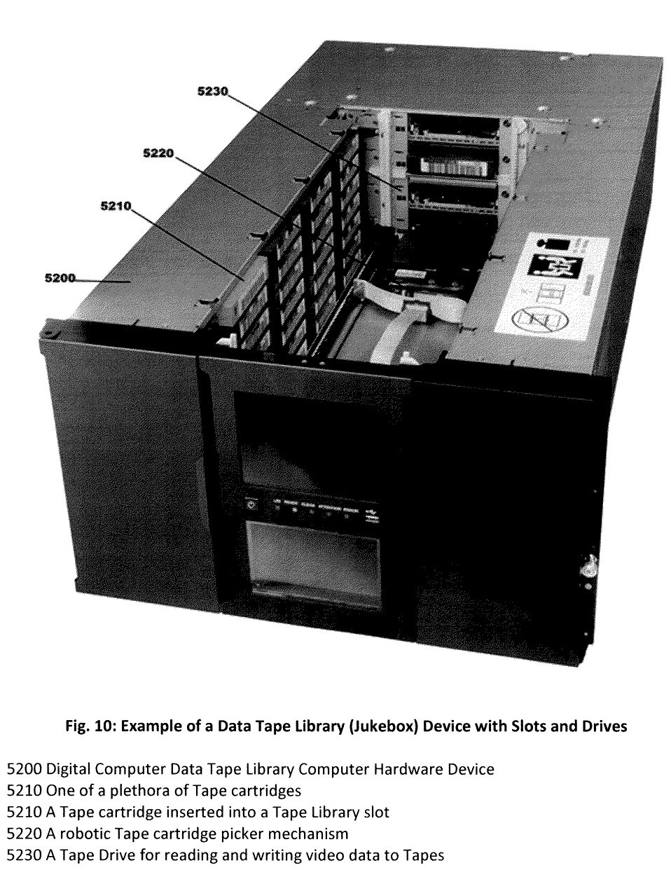

With reference to FIG. 2 the proposed computer software used to automatically manage and facilitate the video data from the various video surveillance cameras would have the typical features of a modern video management software (VMS) program whereby it creates computer network connections to IP-based video surveillance cameras, ingests the video data feeds from those numerous surveillance cameras, 360 creates the appropriate video file for live display and subsequent storage to a hard disk 364. The VMS software is also capable of displaying a Timeline FIG. 9 feature to the human VMS operator that indicates the amount of video that has been recorded and stored and is under VMS management, which allows the human operator to use a mouse to click on a particular date and time on that Timeline in order to recall and playback that recorded video.

With reference to FIG. 2 the proposed invention will have additional computer software, known as middleware, that will interact between the base VMS 200 software and the various hardware components to manage the movement of the recorded video data from one tier of storage 366 to another tier of storage 372. This middleware will also manage a database 5000/6000 that tracks the current location of all recorded video data and interacts with the base VMS 200 software to allow the human video operator to request any available recorded video that is under management in order to recall and playback such recorded video.

This Middleware software, incorporated into the VMS, is what provides the unique functionality of automatically locating the requested video 2102/2110 and controlling the tape library jukebox 5200 in a manner that would load the requested video, no matter which digital computer data tape 5210 the video data was stored upon.

With reference to FIG. 1 a proposed method and set of techniques for ingesting video data from one or more surveillance video cameras 150 into the VMS Software 200 operating on the main computer server FIG. 7 7100. That video data is then processed 300 and recorded onto a first tier 400 of data storage.

FIG. 2 highlights the video ingest process. The proposed invention also needs to utilize specific hardware devices to accomplish the overall process. During video frame ingest procedure 360 we must use an NVMe 7110 memory device within 7100 CPU Server in order to process in a timely manner a plethora of video frames from a plethora of surveillance cameras into individual video files.

The VMS 200 will copy the video frames 360 and ultimately video files 364 from the NVMe 7110 to the first tier of storage 400.

In line with the VMS preset conditions 200, the system will continually monitor the recorded surveillance video on tier one storage 400 and when appropriate replicate 372 that recorded surveillance to tier two storage 500 wherein the surveillance video will be located on both tier one storage 400 and tier two storage 500.

A video operator may at any time request video 150 to be retrieved and played back for review on a video display station 60017170 wherein the proposed invention would automatically retrieve the specified video from either tier one video storage 400 or tier two video storage 500 via the appropriate back-end commands 550 650 without any other steps, human intervention, or video file manipulation.

In order to viably read back and playback specific video surveillance camera data as stated in [0011], the VMS 200 will cluster (or group) specific surveillance camera feeds during the ingest process 366 onto a specified Tape cartridge 5210. This is critical for the solution to work properly in that if video data 364 is replicated to ungrouped Tape cartridges 5210 then the machinations needed to read and playback requested recorded video would become unusable as a solution.

In line with the middleware software, as a specified Tape cartridge 5210 is filled to capacity 374, the middleware will automatically format another Tape cartridge 5210 and automatically remove the now filled Tape cartridge that is already inserted into the tape library drive 5230 and replace that with the newly formatted Tape cartridge.

The middleware software will continually monitor, format, and rotate the Tape cartridges 5210 in and out of the tape library drive 5230 until all available unused Tape cartridges have been filled to storage capacity.

In line with any computer data storage device, this proposed invention tier two storage 500 does have data capacity limitations when considering the capacity of the various computer digital computer Tapes 5210 and the overall size and capacity of the Tape Library device 5200. This proposed invention will take into account these capacities and create a process within the overall method to account for this capacity—also known as retention—capability to monitor and manage such retention. It is acknowledged that as those technologies advance and the data capacities increase, the proposed invention will utilize such data capacities.

As this method and techniques actively monitors and manages the retention capacity of all tiers under management, the system will 380 determine if any specific digital computer data Tape 5210 has reached its data capacity limit and automatically unload and insert a new Tape 5210 into an available Tape Library Drive 5230 to continue recording and storing new incoming video data.

Once all of the available Tapes have been written to with video data, the System's Retention Policies 380 will determine the oldest Tape 5210 used and then reformat that Tape to make that Tape available for new incoming video data to be recorded to once again. This tier two retention policy is a key aspect of the continual operation of the overall System.

Once all previously available Tape cartridges 5210 have been used, the middleware software will identify 380 the oldest video data stored on which Tape cartridge 5210 and then reformat that oldest tape to make data storage available for new incoming video data to be stored.

In line with the VMS preset conditions 200, the system will monitor the capacity of tier one storage 400 and when capacity nears 100% the System will 371 delete the oldest dated video data previously recorded/stored from tier one storage 400.

When this occurs, the surveillance video will only be available on tier two storage 500.

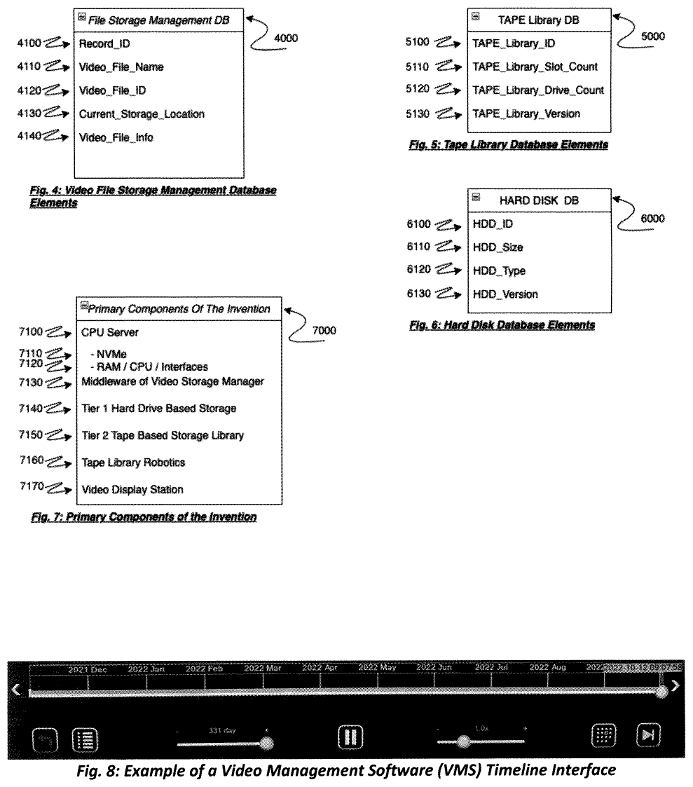

Reference FIG. 3 highlights a proposed specific method and set of techniques of retrieving and displaying requested video by a human video operator. At any time, a human video operator may request a time and date specific video file 2100 from The System utilizing the VMS 200 Timeline bar FIG. 8. The VMS 200 will do an initial hard disk database lookup 6000 then a Tape library database lookup 5000 to determine if the requested video 2102 is located on tier one hard disk based video storage 400 or 2110 on tier two tape based video storage 500.

If the video is determined to be located on tier one video storage 400 then the VMS program 200 will initiate a normal video data storage Read call to retrieve the specified video from tier one storage 400 and that video will be loaded and ready for playback to the human operator.

If the video is determined to be located on tier two video storage 500 then the VMS 200 will initiate a computer program call 2112 to retrieve the specified video—plus a predefined set of minutes (e.g. 15-minutes) before the specified date time requested and a predefined set of minutes (e.g. 15-minutes) after the specified data time requested. All of that identified video data 2112 is then copied back 2114 onto tier one storage 400. The VMS 200 will then load all of the requested and specified video 2020 data into the VMS 200 for display and playback for the human video operator.

If during the FIG. 3 video retrieval and playback process, the video has been determined 2110 to be located on tier two 500 storage a dialog box FIG. 9 will appear in the VMS 200 to inform the human video operator that the video is being retrieved from multiple tiered storage and to stand by as this process could take up to predetermined number of minutes (e.g., eight) FIG. 9.

If during the FIG. 3 video retrieval and playback process, the video has been determined 2110 to be located on tier two 500 storage and the specific video data is located on a digital computer data Tape cartridge 5210 that is not currently in the Tape library drive 5230, the system will control the tape library robotics 5220 to select the tape cartridge that does contain the requested video files, move the tape into an available Tape library tape drive, and advance the tape to the appropriate sector on the tape media where the specific video requested video and copy that video—plus the video data pre- and post-time of the requested video date/time—2114 back to tier one 400 storage all automatically without any human interaction or intervention.

It is critical to appreciate this complete overarching process and how it is unique to any prior art. Currently, there is no other System such as the proposed invention that simultaneously utilizes multiple tiers of video data storage for an active video storage and playback system and integrates the user interface (VMS Timeline) FIG. 8 into one seamless System. By implementing specific computer programming calls as depicted in FIG. 3 and the databases 5000 6000 to register and track where the video files are stored, the VMS 200 can make the automatic determination 2102 2110 as to where to retrieve the requested video either tier one 400 or tier two 500 utilizing the Tape library jukebox 5200.

It is this process that allows for the seamless video retrieval and playback of all the video that has been recorded and stored in the System. If the proposed invention was not available, the human video operator would have to engage with other software packages and personnel to locate and make available to needed video.

Special attention needs to be focused on the video retrieval and playback functionality of this proposed invention whereas other prior art may make use of multiple tiers of video data storage, those systems do not provide for an automatic, seamless, non-interventive method for identifying, locating, and playback of the recorded video.

Special attention needs to also focus on the proposed invention wherein it does not attach and pre-determined priority, importance, or value to the video data, as it is the perspective of the inventor that all video has the same level of importance and value and must be stored.

Special attention needs to also focus on the proposed invention wherein no video is altered in resolution, frame rate, or compressed in any additional manner as it is the perspective of the inventor that all video must remain as originally recorded for chain of custody and evidentiary value.

What is claimed is:

1. A method with the underlying computer program for an overarching video surveillance management platform encompassing of a video management software (VMS) program, integrated with middleware software, all of which actively ingests, records, and stores video data to multiple tiers of video data storage, manages the movement of recorded video data amongst the various tiers of storage, all for the purpose of unimpeded video playback of any available recorded video by a human video operator.

2. A system of integrating computer hardware devices comprising of a standard computer server, with appropriate computer memory storage, NVMe flash storage module, traditional hard disk data storage, and digital data tape storage such as Linear Tape Open (LTO) or T10000 format in such a manner to facilitate the moving of data through multiple tiers of data storage.

3. A method with the underlying computer program (middleware) that manages the various interactions between the base VMS software and that of the associated storage hardware devices.

4. A portion of the VMS software program derived from claim 1, that includes the underlying methods that actively ingests, records, and stores surveillance video from various surveillance cameras initially to an NVMe flash storage module and then onto a first tier of hard disk-based storage.

5. A portion of the VMS software and middleware program derived from claim 3, that automatically manages and controls a complex digital computer data tape library device comprising of one or more digital computer data tape drives, one or more tape cartridge slots, and the robotic gripper/picker armatures, and elevators to move tapes as needed through the tape library device.

6. A portion of the VMS software and middleware program derived from claim 3, that continually manages the available storage capacities of each tier of storage.

7. A portion of the VMS software and middleware program derived from claim 3, that automatically replicates video data from tier one hard disk to second tier tape storage.

8. A portion of the VMS software and middleware program derived from claim 3, that automatically groups the recorded video data by camera onto an automatically specified second tier tape storage cartridge as opposed to a chaotic fashion to ensure viable reading and playback of needed video data at a later time.

9. A portion of the VMS software and middleware program derived from claim 3, that automatically deletes video data from hard disk tier one when tier one storage is nearing capacity limits of that tier of storage.

10. A portion of the VMS software and middleware program derived from claim 3, that automatically deletes video data from tape-based tier two storage when tier two storage preset retention policy limits have been reached and automatically reformats the Tape for re-use.

11. A portion of the VMS software and middleware program derived from claim 3, that automatically assigns, formats, and makes available the next tape cartridge within the tape library for continual video storage.

12. A portion of the VMS software program derived from claim 1, for when a human video operator requests to playback specific video, wherein a process of the VMS checks if the requested video is on tier one storage and if that check determines that the requested video is not on tier one storage then checks to determine if that requested video is on tier two storage.

13. A portion of the VMS software and middleware program derived from claim 3, that once operator requested video has been identified as being located on tier two tape storage, will automatically replicate that needed video—along with recorded video on a preset amount of time either side of the requested video (e.g. 15 minutes before and after)—back to tier one hard disk storage for immediate reading of such data and video playback.

14. A portion of the VMS software and middleware program derived from claim 3, a process that when requested video is on tier two tape storage and that the requested video is located on a specific tape cartridge not already inserted into the tape library tape drive, the tape library will automatically select the appropriate tape cartridge with the requested video data files and re-insert that tape into the tape library tape drive.

15. A portion of the VMS software and middleware program derived from claim 3, wherein it will manage the amount of time any recently inserted tape will remain within the tape drive of the tape library, before it is removed and replaced into its designated tape slot within the tape library.

16. A portion of the VMS software program derived from claim 1, wherein no additional steps outside of those detailed herein nor any other human intervention is required for the human video operator to receive the requested video displayed and available for review, providing seamless video playback to the VMS software.

17. A portion of the VMS software program derived from claim 1, wherein it is specifically claimed that there is no need for any reduction in the video frame resolution or the reduction in the number of video frames recorded, nor any other quality or file size reduction is necessary.

18. A portion of the VMS software and middleware program derived from claim 3, to add new digital computer data tape storage libraries to the System to expand the retention capacity of recorded video as needed.

19. A portion of the VMS software program derived from claim 1, wherein the timeline feature of the VMS software is the only human interaction that is needed to initiate the video retrieval and playback.
